(19) United States
(12) Patent Application Publication
(10) Pub. No.: US 2022/0012420 A1
(43) Pub. Date: Jan. 13, 2022

(54) PROCESS, SYSTEM, AND METHOD FOR COLLECTING, PREDICTING, AND INSTRUCTING THE PRONUNCIAITON OF WORDS

(71) Applicant: NameCoach, Inc., Stanford, CA (US)

(72) Inventors: Cynthia Henderson, Stanford, CA (US); Jack Green, Stanford, CA (US); Praveen Shanbhag, Stanford, CA (US)

(73) Assignee: NameCoach, Inc., Stanford, CA (US)

(21) Appl. No.: 17/371,081

(22) Filed: Jul. 8, 2021

Related U.S. Application Data
(60) Provisional application No. 63/049,432, filed on Jul. 8, 2020.

(51) Int. Cl. G06F 40/20; G09B 5/02; G09B 5/04

(52) U.S. Cl. CPC G06F 40/20; G09B 5/04; G09B 5/02

(57) ABSTRACT

The present disclosure relates to a system and method. The system includes a computer server and a processor, which receives a request for pronunciation of a target name by a user. A database may store one or more name pronunciations for one or more names. The computer server compares the target name received in the requested pronunciation of the target name with one or more of the name pronunciations in the database to identify a ranked list of pronunciations of the target name. The computer server may provide the ranked list of pronunciations of the target name to a user device associated with the user.

### TECHNICAL FIELD

This disclosure relates to a process for collecting, predicting, and instructing users of a computer based system to correctly pronounce words, in particular names, based on a variety of factors in order to instruct the users on how to properly pronounce the name of a person the users are uncertain about.

### BACKGROUND

Verbal communication is ubiquitous in our society and enhances our lives. For example, family life is enriched with instructing children, communicating with a spouse, and expressing emotions with them; entertainment is enhanced with movies, podcasts, music, comedians; education is heightened with classroom lectures, group projects, and guest speakers; sports are improved with cheering fans, communications with other players, sports commentary, and expressing disagreements with referees. Much of the success of verbal communication stems from the ability to properly pronounce the words.

Proper pronunciation can increase in complexity when there are multiple pronunciations of a word. These pronunciations can be regional or depend on ethnicity. For example, pajamas, crayons, syrup, and pecan pie have different pronunciations depending on the region. Mispronunciation of words with multiple pronunciations could label the user as an outsider which may limit opportunities. This in turn may lead to ridicule through teasing, mocking, or being considered an “outsider.”

Other words that require proper pronunciation are people's names. Proper name pronunciations not only help to maintain the grandeur of an event but also show respect for a particular person by being familiar enough or polite enough to take the effort to pronounce their name correctly. In contrast, name mispronunciation can lead to both embarrassment for the speaker and lowered sense of inclusion and respect for the name owner. These events may include weddings, sporting events, employment salutations, classroom, interviews, award ceremonies etc. Many factors may affect name pronunciations; the linguistic rules for converting name spelling into pronunciations vary between geographic region, demographics within a region, and also different periods within history. As a result, name pronunciation may change according to the name owner's date of birth, place of birth, current residence, gender, socioeconomic status, race, religion, political preference, parents' place of birth, parents' date of birth, parents' nationality, and etc., including the past movement of a family with a single family surname across different linguistic regions in prior generations. Some demographic or geographic information may have a greater effect on pronunciation but, trying to determine which factors affect pronunciation more makes it difficult to predict how to properly pronounce someone's name. In addition, speakers may be unfamiliar with the pronunciation rules of names from other regions or demographics, reducing their ability to accurately predict name pronunciation based on spelling and prior verbal interactions; also impairing their ability to remember and replicate name pronunciation from prior verbal interactions. Similar problems may occur when pronouncing city names or the names of other geographical locations in a certain location. Utilizing stored information of proper pronunciation and/or statistical information or machine learning to predict proper name pronunciation is at least one object of the following disclosure to improve the accuracy and predictability of name pronunciation.

### SUMMARY OF THE DISCLOSURE

Described herein is a system. The system includes a computer server and a processor, which receives a request for pronunciation of a target name by a user. A database may store one or more name pronunciations for one or more names. The computer server compares the target name received in the pronunciation request against one or more pronunciation in the database to identify a ranked list of pronunciations of the target name. The computer server may provide the ranked list of pronunciations of the target name to a user device associated with the user.

A method is further disclosed. The method may include receiving by a processor, a request for a pronunciation of a target name by a user. The method may further include comparing, by the processor, the target name to one or more name pronunciations for one or more names stored in a database. The method may further include identifying, by the processor, one or more name pronunciations matching the target name receive din the request for pronunciation of the target name by the user. The method may further include ranking, by the processor, the identified one or more pronunciations for the target name received in the request for pronunciation of the target name by the user in a ranked list of most recommended to least recommended name pronunciations of the target name. The method may also include transmitting the ranked list of pronunciations of the target name received in the request for pronunciation of the target name to a user device associated with the user.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a system for collecting, predicting, and instructing in the pronunciation of words.

FIG. 2 illustrates a diagram of an interaction between a user, a processor and a database in a process, system, and method of collecting, predicting, and instructing the pronunciation of words.

FIG. 3 illustrates a device having a user interface for collecting and instructing the pronunciation of words.

FIG. 4 illustrates an exemplary word pronunciation recommendation method.

FIG. 5 illustrates an exemplary method 500 for converting text-based name input to an audible pronunciation of a name.

FIG. 6 illustrates an exemplary method 600 for converting audible name input data into text-based name output data.

### DETAILED DESCRIPTION

In the following description of the disclosure, reference is made to the accompanying drawings, which form a part hereof, and in which is shown by way of illustration specific implementations in which the disclosure is may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

Finally, it is further noted that references to word pronunciation and name pronunciation are intended to be different. The pronunciation of common words in any language, but particularly English, are governed by linguistic rules that are commonly accepted among speakers of the language. Name pronunciation is more difficult because many names are not native to the English language or do not follow the same linguistic rules as other words in terms of pronunciations. Thus, it is noted that while the techniques herein may equally be applied to word pronunciation, this disclosure is explained with respect to the more complicated case of name pronunciation. However, name pronunciation is not intended to limit the scope of this disclosure to only names as the techniques described herein may be equally applied to word pronunciation for language learning, curing speech impediments, and speech therapy.

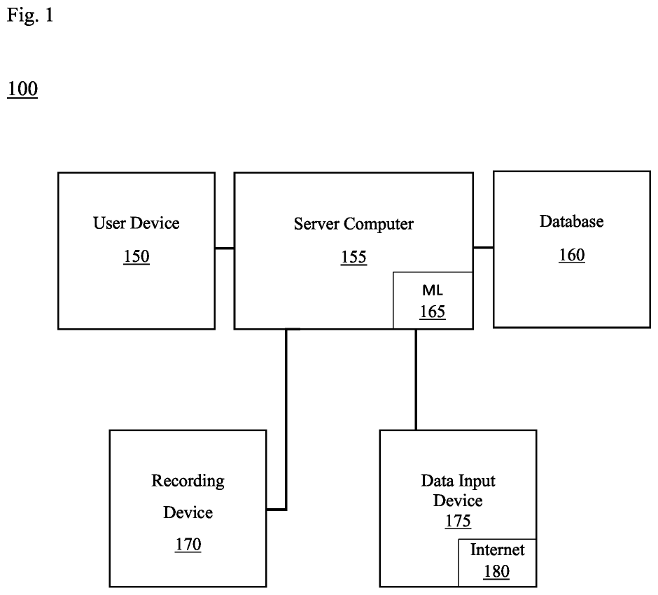

FIG. 1 illustrates a system 100 for collecting, predicting, and instructing in the pronunciation of words. As shown in FIG. 1, system 100 may include a user device 150 which may interface with server computer 155. User device 150 may be a computing device. Examples of computing devices include smart phones, personal sound recorders (e.g., handheld audio recording devices), desktop computers, laptop computers, tablets, game consoles, personal computers, notebook computers, and any other electrical computing device with access to processing power sufficient to interact with multicomputer network system 400. User device 150 may include software and hardware modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within user device 150 may be used to execute the various computer applications, methods, or algorithms disclosed herein independent of other devices disclosed herein.

Server computer 155 may be implemented as a single server, multiple connected server computers, or in a cloud server implementation. The one or more server computing devices may include cloud computers, super computers, mainframe computers, application servers, catalog servers, communications servers, computing servers, database servers, file servers, game servers, home servers, proxy servers, stand-alone servers, web servers, combinations of one or more of the foregoing examples, and any other computing device that may execute an application and interface with both user device 150 and database 160. The one or more server computing devices may include software and hardware modules, sequences of instructions, routines, data structures, display interfaces, and other types of structures that execute server computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within one or more server computing devices may be used to execute the various methods or algorithms disclosed herein, and interface with user device 150 and database 160.

Server computer 155 may further include a machine learning processor 165 which applies machine learning techniques as described herein. Machine learning techniques may include the use of artificial intelligence to extrapolate patterns which iteratively teach a processor how to perform a desired task more efficiently with more accurate results over time. In one embodiment, artificial intelligence and machine learning techniques may be applied to recommend a name pronunciation for a particular person based on previous recommendations and their relative accuracy.

Database 160 may be a data storage repository for pronunciation information, demographic information, name history information, and any other data that may be stored to execute the methods and systems herein. Database 160 may be implemented as volatile or nonvolatile memory, to facilitate information retrieval and storage for server computer 155.

System 100 may further include a recording device 170 which may be connected to server computer 155 or user device 170, in some embodiments. Recording device 170 may include a microphone, for example, which may receive pronunciation information from a hired voice actor, as will be discussed in more detail below. Recording device 170 may be appropriate for studio recordings of name pronunciation information and may include sound processing equipment to obtain quality sound recordings with high fidelity. Recording device 170 may, therefore, include a microphone, an audio recording device with associated memory for recording incoming audio data (which may be implemented through database 160) and may function to facilitate the recording and provision of pronunciation data to server computer 155.

System 100 may further include a data input device 175 which may also be referred to as an administrator computer with access to the Internet. In some cases, it may be desirable to access demographic data, name data, or other information from the Internet to incorporate that information into database 160. Data input device 175 may also serve to provide data to server computer 155 that may be used to train machine learning processor 165 on how to improve name pronunciation recommendations, as will be discussed below.

System 100 may be used to generate a recommended name pronunciation for a particular person in a variety of ways, which will be disclosed below. System 100 may obtain information from data input device 175, for example, that may assist in using a name parser which is useful in obtaining a wide but not deep set of information for names collected and stored in database 160. The name parser may be executed by server computer 155 and machine learning processor 165 to collect names or lists of names in a lowest information state. The name parser may, for each collected name, find all name components (phonetic components—e.g., lowest information state), remove punctuation, standard formatting, and maps data to information in database 160 that stores an audible pronunciation of each name as a stored file in the database. At the same time, the name parser may identify or tag further information associated with the name for identifying information about the name. For example, the name parser executed by server computer 155 may identify a difference between “LOREAL”® and “L'ÔREAL”® because the addition of the apostrophe and the circumflex in the latter example is indicates an origin of the word, in the case, particularly French. The origin of the word may be useful in determining an appropriate pronunciation of the name.

For example, information may be gathered through data input device 175 about an origin for a particular name and gather data about a user or a name owner. Data may be gathered about a person's background, such as a phone area code, an address associated with the person, personal information derived from social media, place of birth, the schools the person attended, and other background information that may provide demographic information about the person which affects pronunciation of the person's name. For example, a person who is born in New York, and lives in California, and who has family in Ireland with a long family history may be recommended to have a name with a more Irish pronunciation than an American pronunciation. The names of the person may be combined to determine what region of the Earth the names were most common in terms of ethnic origin or linguistic origin and where that person was raised and currently lives (based on phone, address, and other information). For example, John O'Malley may be determined to be of Irish descent and have strong ties to Ireland, which may affect a name pronunciation recommendation for pronouncing John, for example.

Another factor of a name pronunciation recommendation may be database recordings to estimate the origin of each pronunciation query submitted to server computer 155 by, for example, user device 150. Database 160 may store recordings of name pronunciation provided by professional voice actors or by students who have provided a recording of their preferred name pronunciation to database 160. The professional voice actors may use a recording provided by someone else, such as a student or an employee, and reproduce the pronunciation for capturing by high quality recording equipment to obtain a better recording of the sounds when pronounced by the voice actor. External inputs provided by data input device 175 may determine or estimate an origin for the name and compare the provided pronunciation to other known pronunciations of the same name to determine if there are differences and if there are differences, what those differences may be. For example, for certain names that are popular in other countries, such as India, for example, the same name may be pronounced in different ways based on whether or not the person providing the recording is from northern India or southern India. Native speakers from India may be more adept at making the distinction between northern Indian pronunciation and southern Indian pronunciation, which can be identified by server computer 155 and machine learning processor 165 to provide a recommendation based on demographic data of the particular person. When a name is provided merely as text, if an address or family history of a person can be identified, the recommendation may be for the northern or southern Indian pronunciation. Another possible way to identify correct recordings, in addition to those techniques mentioned above, may be to hire professional voice actors who know other people with a particular name and hire that contractor to speak a name for recording using, recording device 170, for example.

Once data is populated within recording database 160, a recommendation algorithm may determine whether or not accurate matches for a particular name exists within the database. For example, a student guide at an orientation event may meet a new student guide who wears a name tag that says “Sertia” on it. However, the student guide may have never seen the name “Sertia” and have no idea how to pronounce the name. In this case, the student guide may access user device 150 and provide the name “Sertia” by text to server computer 155 in order to be provided a set of pronunciations for the name “Sertia” either as audio or phonetic transcriptions for how to pronounce the name “Sertia.” Server computer 155 may access database 160 to determine whether or not there is a pronunciation provided by Sertia to be stored in the database through the school. If such a recording does not exist, a recommendation may be made based on the origin of the name with a current U.S. accent, based on origin information about the name Sertia, or machine learning techniques. As will be discussed below, a user may be presented with an opportunity to provide user feedback through user device 150 which indicates whether or not the provided pronunciation was or was not accurate.

Server computer 155 may further consider additional elements in recommending a name pronunciation such as a voice quality of a recording or translation accuracy. For example, if it is determined that a name pronunciation for “Henri” may have numerous pronunciations (e.g., based on a French accent or a Quebecois accent, a Cajun accent, or a French African accent), absent indications of location or other information, server computer may provide a recommendation based on which pronunciation in database 160 has the highest quality recording. Translation accuracy may also be relevant as part of determining a “highest quality recording” and based on demographic and location information, to the extent that information for the pronunciation is available. For example, “Pietro” may be translated as “Peter” in English and if a pronunciation of “Pietro” is not found within database 160, server computer 155 may recommend “Peter” as a pronunciation as being an accurate translation of the word “Pietro.”

It is possible that a plurality of results could be generated as recommendations for pronunciation of a name even when origin information, demographic information, location information, recording quality, and translation information is applied to filter results for a particular name by server computer 155. In such a case, a predetermined number of results may be selected using the foregoing criteria may be combined with previously received user feedback to determine which results to show. For example, a user may indicate by user device 150 that a recommended pronunciation was accurate or not accurate. In this case, pronunciations that are determined to be inaccurate may be disfavored for recommendation by server computer 155. In some cases, a user may select a favored pronunciation within database 160 for their own name via user device 150 in, for example, a user profile associated with user device 150. Based on which pronunciations are recommended, an up vote or down vote (e.g., a positive or negative user response to the provided pronunciation) may be provided in that more positively regarded pronunciation recordings are indicative of higher accuracy in the pronunciation. Accordingly, recommendations for pronunciations that are rarely or infrequently selected may be disfavored in providing future recommendations for other users inquiring through user device 150 about how to pronounce a particular name. In other words, individual response to particular recordings may also be a factor in determining a recommendation for pronunciation of a particular name.

Finally, if no information has been derived about a particular name, and the quality or accuracy of any pronunciation available in database 160 is low, server computer 155 may establish an equivalent pronunciation using machine learning processor 165 to make an effective “best guess” at pronunciation based on the letters in the name and commonalities between that name and other names in database 160. For example, if one name is unknown to server 155 and database 160, elements of the letters in the name may be identified which may be associated with commonalities to names that are known to server 155 and database 160. For example, if the name Shanbhag was unknown to server 155 and database 160 but the name Deodhar was known to server 155 and database 160, server 155 may determine that a silent “H” in Deodhar may imply that the name Shanbhag also has a silent “H” and that both share a common origin in the Hindi language. Server 155 may then use this information to determine that a “B” and a “D” are both dental sounds (phonemes) and that the “H” following the “B” in Shanbhag and “D” in Deodhar is likely not pronounced and provide an “equivalent” pronunciation as a “best guess.”

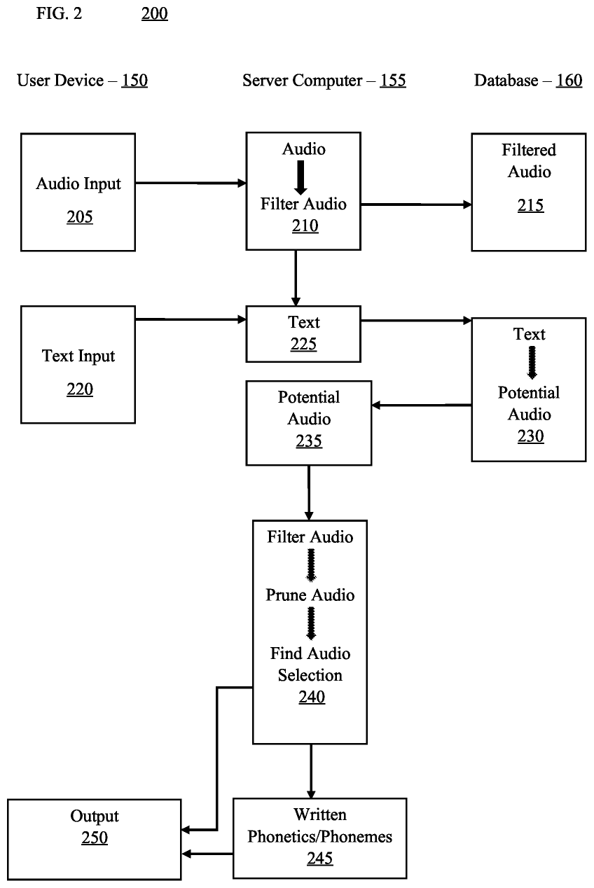

FIG. 2 illustrates a diagram of an interaction between a user, a processor and a database in a process, system, and method 200 of collecting, predicting, and instructing the pronunciation of words. Method 200 is shown with respect to elements shown in FIG. 1, such as user device 150, server computer 155, and database 160. A user via user device 150 may upload an audio input 205 to a server computer 155 which may be output as a text output 250 (e.g., speech is converted into text representative of the recorded speech). Audio input 205 may be recorded in a variety of formats that may include a compressed format, an uncompressed format (i.e., LPCM, PCM,), lossless compressed format (i.e., FLAC, ALAC, WavPack, Monkey's Audio), and/or lossy compress format (i.e., MP3, MP4, AAC format) or any other recording format known in the art. After server computer 155 receives the audio input 205 and runs it through filter 210. Filter 210 may be used to filter certain elements of the audio recording. Audio input 205 may include a speech recording of a user. After audio input 205 is received and passed through filter 210, audio input 205 may be saved as filtered audio 215 in database 160. As previously discussed, database 160 may include various categories of information. Some of this information may include demographic, geographic and other statistical information associated with the recording. Database 160 may include a text and associated audio recording 230. Server computer 155 may also receive text input 220 and the received text 225 may be compared to the text and associated audio 230. The processor may then select a text and associated audio recording 230 that best correlates or is the most similar to the audio input 205. Potential audio 235 is further processed by narrowing 240 that may include filtering the audio, pruning the audio and having a final audio selection. Once the one or more audio selection is chosen, server computer 155 selects a text of phonetics and or phonemes 245. Text 245 then is sent to user as output 250.

This system uses a database that collects audio recordings of word pronunciations (i.e., people's names, town names, county names, city names, or other words in a given language or languages). These names or words may be collected by uploading an audio recording using a microphone that is connected to a processor. This recording may be stored in database 160, i.e., general pronunciation database (“GPDB”). Other databases may be included or connected to the GPDB. Additional information may be stored in the database that includes geographic, demographic, and other statistical information about the individual who is the voice of the audio recording. For example, if an individual is recording a name, some information entered may be whether or not this is her own name, her date of birth, her place of birth, her nationality, her parents' nationality, her religious affiliation, her first language, her socioeconomic status, name-based origin information, and etc. Other relevant information that may affect pronunciation may be included. This information may be compiled and curated according to its pronunciation relevance. For example, an audio recording of the user's own name may be of more importance than an audio recording of a grandmother pronouncing her granddaughter's name. This curated and compiled information can be used to predict, coach, and or teach word pronunciation.

A user may seek to find the pronunciation of a word or name. The user may input audio recording of the suspected pronunciation of a word or name. This may be done by speaking into a microphone in user device 150 or recording device 170 connected to server computer 155 that is connected to database 160. Once the audio is input the processor receives that audio and filters the audio to make the audio more compatible. This filtered audio may be saved and curated within the database. Server computer 155 may then translate the speech into a text form to make search in the database more efficient. Subsequently the one or more audio related to the user's audio input is selected from database 160. The user may include additional information to further narrow a search performed by server computer 155. For example, the user may be looking for the most common pronunciation for the name of a guest speaker named Laurel. The user knows that Laurel and her family has lived in St. Cloud, Fla. for generations and she is 37 years old. Server computer 155 may use this demographic, geographic and statistical information to narrow the search. Using the information available a set of most likely pronunciations for this name may be chosen. In addition to one or more possible pronunciations a phonetic and or the phonemic expression of the pronunciations in text form may be included.

The system may also include a speech to phonetics/text and text to speech capability to analyze a name pronunciation given by users to create a pronunciation recommendation or set of training hints to teach the user how to pronounce the name more correctly. Name corrections/trustworthiness indicators may also be present. The text to speech may include text to speech pronunciation suggestions. The suggestions may include phonetics and or phonemes to aid in the pronunciation process. The user may speak into a microphone connected to server computer 155. The user then may attempt the pronunciation using the phonetics and or phonemes as guides. The system may be able to compare the two recordings (one from the database and one from the user) and determine whether the two recordings match. If the recordings are different the system may determine what differences were present and where the differences occurred. After determining the differences, coaching instructions may be sent to the user to practice the pronunciation once again. When a name or a word is spoken the system may determine not only the spelling but the phonetics/phonemes that are used in the pronunciation.

Text to phonetics/phonemes may be used to aid in the pronunciation of a word and may include an audio recording using human audio recordings form database 160. Data science models can be split into two groups: algorithm/statistical data models, which use algorithms and statistics to better group and understand the data; and machine learning, in which machine learning models are applied to either improve on algorithmic data models or produce entirely new functionality.

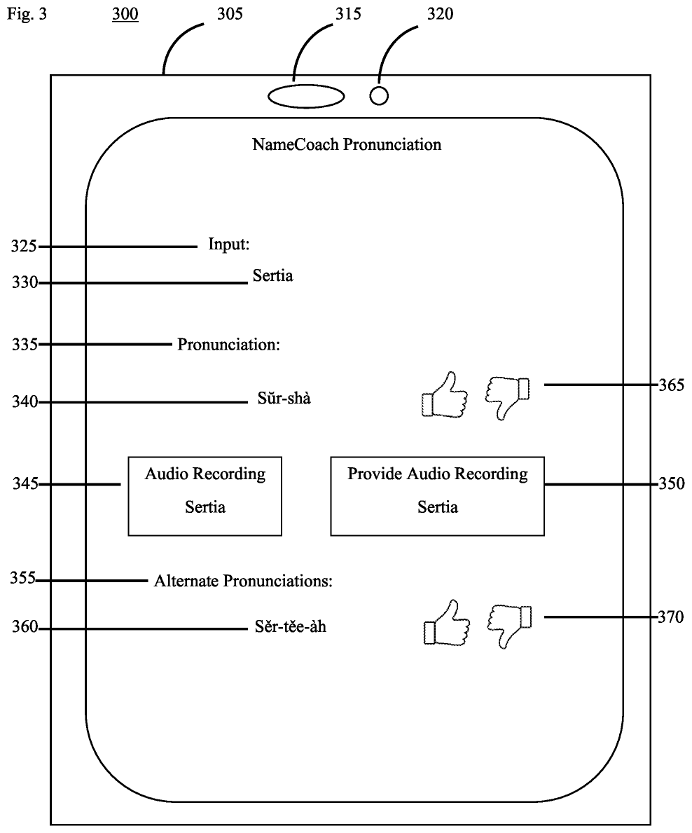

FIG. 3 illustrates a device 305, such as user device 150 shown in FIG. 1, having a user interface 300 for collecting and instructing the pronunciation of words. As previously discussed, user device 150 may be implemented as a variety of computing devices, including a smart phone device 305, which is presented here as one suitable, although exemplary, device for user device 150. Smart phone device 305 includes a display screen 310 which may be touch sensitive for interaction with the device by the user by touch. Smart phone device 305 may further include a speaker 315 and a microphone 320 (as well as a number of other elements, such as a camera and buttons which are known to be included in most smart phone devices). Display screen 310 of smart phone device 305 may display indicia and information concerning name pronunciation recommendations. For example, at element 325, display screen 310 may indicate that a user is providing input (e.g., a name) for which a pronunciation recommendation is requested. As will be discussed below, this input may be provided via textual input or via audio input spoken by the user. Once input is provided, smart phone device 305 may contact server computer 155 to determine, or may locally determine, that the provided input is the name “Sertia.” For example, smart phone device 305 may use a speech to text algorithm, which will be discussed below, or a text to speech algorithm, to query server computer 155 for a pronunciation which may be displayed as element 335 in user interface 300. Server computer 155 may apply the foregoing techniques, particularly those discussed with respect to FIG. 1, to provide a recommended pronunciation for the name “Sertia” at element 340 of user interface 300.

Smart phone device 305 may further provide an interactive button 345 for the user to hear an audio recording of the pronunciation of the name “Sertia” which requests server 155 and/or an interactive button 350 to provide an audio recording of the pronunciation of the name “Sertia.” If server computer 155 determines that alternative pronunciations are available, although not recommended or less likely to be accurate, alternative pronunciations 355 may be displayed as element 360. A user may vote using a positive or negative feedback icon 365 such as a “thumbs up/thumbs down” icon as to the accuracy of pronunciation at element 340 or at positive or negative feedback icon 370 for the alternative pronunciation at element 360 to indicate whether or not the recommendation is accurate or if the alternative recommendation is accurate.

As previously discussed, user device 150 or server computer 155 may convert provided text to speech with a pronunciation recommendation. In some cases, server computer 155 may use machine learning via machine learning processor 165 to determine an accurate pronunciation of a provided name, for example, based on text input into user device 150. Determining a pronunciation, as previously discussed, is difficult because name pronunciation, in many cases, does not follow the same linguistic rules as other words in a language. Further, the same spelling of a name may result in multiple correct punctuation based on a particular person's preferences. While speakers of the English language are particularly adept to different pronunciations of the same words (read/read, lead/lead, live/live), a speaker's meaning of these words is based on context whether these words are spoken or are read by a user. Thus, while conventional technology can accurately identify common words in text to speech applications, there is no adequate solution for correctly converting textual name information to audible speech information with any reliable pronunciation accuracy. In other words, conventional technology makes no effort to distinguish “Henri” from “Henry” in text to speech applications.

To address these issues, preferably server computer 155, or user device 150 may break text provided as input, for example as element 325 in FIG. 3, into phonetic constituent elements of the text. In some cases, the resulting break of the text may or may not be readable by humans. This encoded text may be analyzed by server computer 155 against information stored in database 160 to convert this broken text into an audio output based on the phonemes within the textual input and based on phonetic rules established for name pronunciation. Phonetic rules established for name pronunciation may be generated based on the pronunciation recommendation model discussed with respect to FIG. 1 in order to accurately identify a pronunciation for the provided text. Similarly, a phoneme may be selected based on the pronunciation recommendation model and phonetic rules stored for names with consistent constituent elements. For example, commonalities between different names may be identified in terms of letters used to represent the name, name origin information, location information, ethnicity information, and other information may be used to derive a recommended pronunciation based on the recommendation model discussed with respect to FIG. 1 above, to create a phonetic pronunciation representation in speech for a name supplied as input with text as a series of letters input into user device 150. The pronunciation recommendation may be output by a speech synthesizer to produce an audible pronunciation of the name provided in text form in order to instruct a user how to pronounce a name that is, for example, typed into user device 150 as text input.

Another common problem is using names in speech to text applications as conventional technology is inadequate to correctly identify that 1) a name was spoken and 2) who the name is associated with. For example, using a speech recognition feature on a smart phone and asking the phone to “Call Sertia” may result in the phone calling “Santa,” which is becoming more of an issue as speech recognition features are incorporated into devices beyond smart phones, including smart speakers, smart hubs, and similar room or home-based assistants.

One solution to such an issue is to convert a spoken word into a textual representation that may be much more efficient for a computer to recognize accurately. In one embodiment, server computer 155 may receive spoken name data from user device 150 and use the name pronunciation recommendation model discussed above with respect to FIG. 1 to identify phonemes in the spoken speech. Once the phonemes are identified, a spelling associated with those phonemes may be generated as a text-based estimation of spoken name. The text-based estimation may be compared to a known list of names, such as in a particular user's digital address book or list of contacts stored within user device 150 to identify potential names in the list of contacts as being consistent with the name that was spoken. If multiple names are identified, computer server 155 may parse conflicts based on the differences between the names in the contact list and the probability, based on the text-based estimation, that a particular name was intended over another name. A computer may, by simple comparison, compare an estimated text representation of a spoken name to text stored elsewhere, such as in a user's contact list, and identify with a degree of likelihood, that a particular contact is the contact whose name was spoken by the user.

For example, if Sertia is identified by user device 150 as a common contact and Santa is identified as a once-a-year contact, the probability, as determined by server computer 155, indicates that Sertia is more likely to be the person whose name was spoken by the user. In this manner, computer server 155 and user device 150 may cooperatively and accurately identify a person based on a name being spoken into a speech recognition system.

As shown in FIG. 3, a pronunciation suggestion element 340 may be provided via user interface 300. At the same time, the pronunciation representation of recordings that may be accessed through interactive buttons 340 and 345 may be stored in the database as a phoneme or series of phonemes. A user may, via a customer profile or user profile associated with a user account, use user interface 300 to obtain a visual representation of the pronunciation of a name. The visual representation may include a phonetic display of the name, for example. The representation may also be stored with the user profile and function with either text to speech functionality or speech to text functionality described above. In other words, a phonetic representation of a name may be provided for a particular customer and be stored along with a customer profile as a name pronunciation associated with that particular customer's profile. This phonetic model may be maintained in database 160 and accessed via user device 130 and computer server 155 to provide visual representations of phonetic pronunciations of any name stored in database 160.

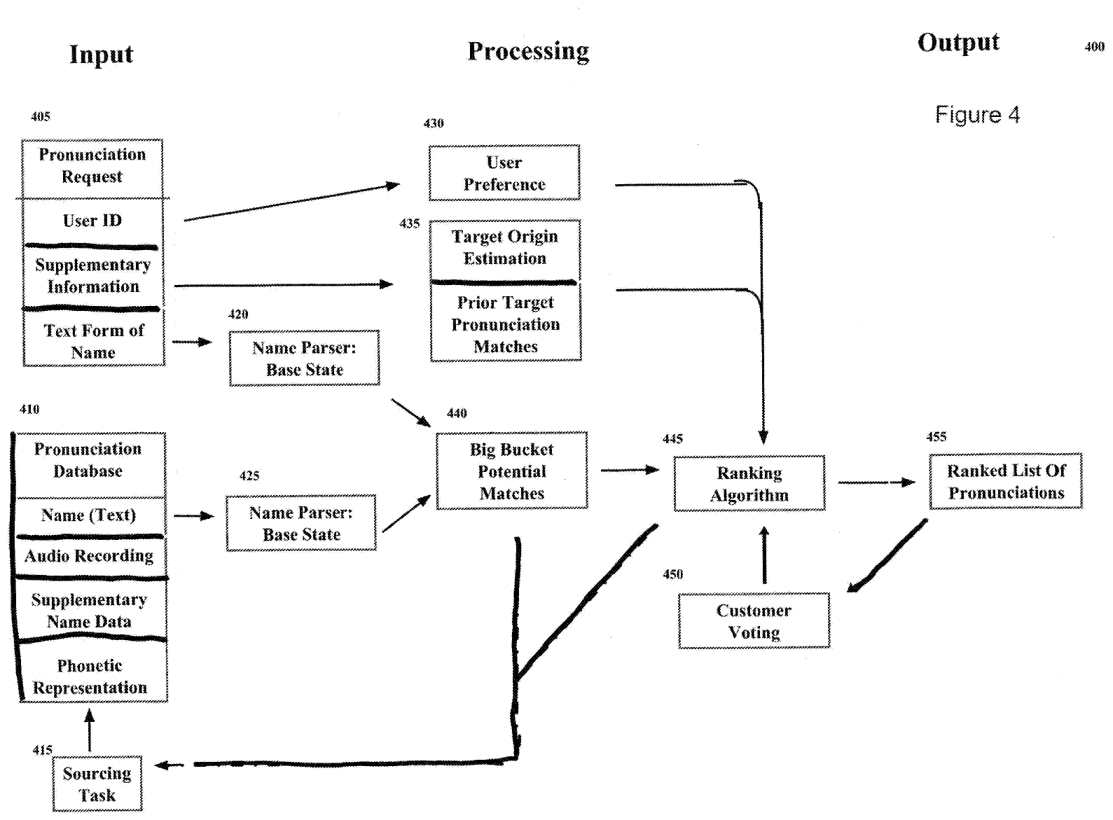

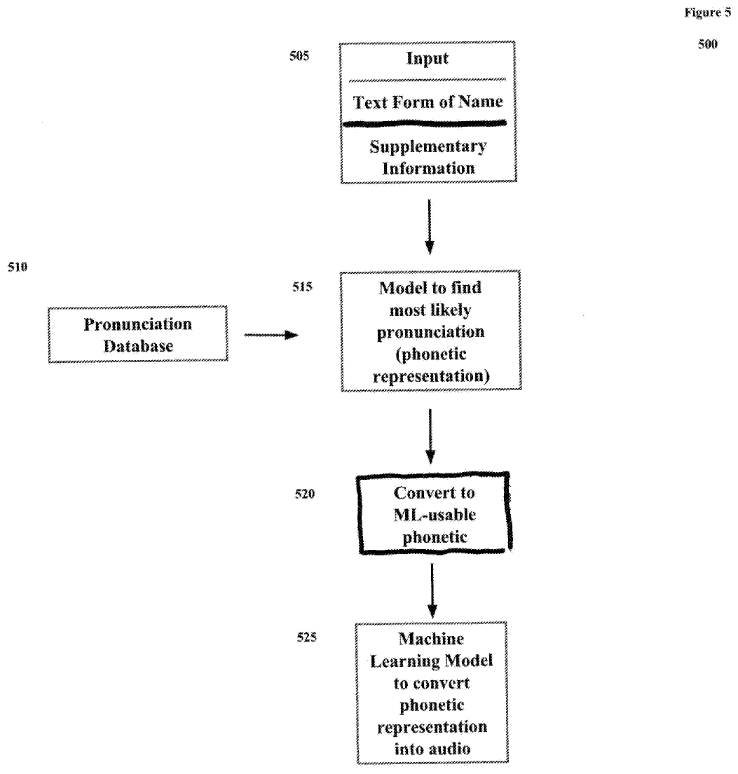

FIG. 4 illustrates an exemplary word pronunciation recommendation method 400 executed by system 100, shown in FIG. 1, for example. Explained another way, various name pronunciation options 410 are provided as recordings and/or text-based phonetic representations via user device 130, for example, which then outputs a pronunciation result 455 based on the provided name data from name sourcing element 505 (shown in FIG. 5) via a speaker 315 on user device 130. Method 400 includes processes and steps for converting a “target” text-based name input to a ranked list of potential audible pronunciation and/or visible phonetic representations for that name, which occurs as a result of the flow of information between system 100, showing in FIG. 1, for example.

Method 400 begins at step 405 where a user device, such as user device 150 receives text-based name input of a “target” name, such as “Sertia.” This text-based name input may be accompanied by supplementary information that may or may not help predict the most likely pronunciation of the name. For example, the text name input may be submitted through tooling embedded in a platform such as Salesforce, in which there may be additional information recorded about the target of the name pronunciation such as phone number or email. In addition, the target name itself can provide supplementary information, for example, the name may be prevalent in certain geographical regions and therefore be suggestive of certain name origin information. This text based name input may also be accompanied by user or other information that may or may not help determine the desired pronunciation output; for example a user based in the USA may prefer versions of a pronunciation that are pronounced using USA accents and USA phonetics rather than being spoken in their original accent, which the user may find hard to mimic.

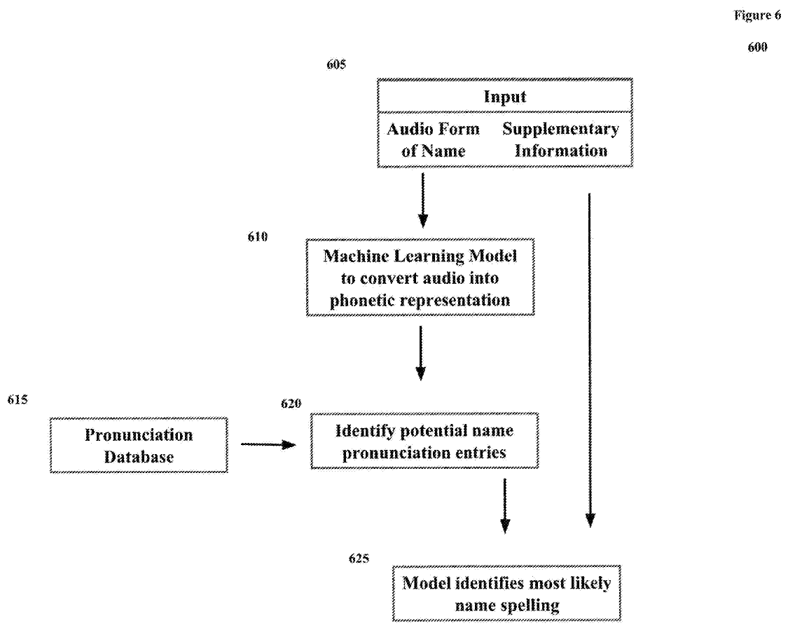

Step 410 describes a database of name pronunciations, which may include text-based representations of names and audio-based representations of names. For example, an entry for “Sertia” may be linked to both the text “Sertia” as well as an audio clip of a speaker pronouncing “Sertia”. These audio recordings may or may not be original recordings of individuals saying their own name (“source recordings”) and may or may not be adapted recordings produced by voice actors or machine learning models mimicking the pronunciations of source recordings to transform them into professional-level recordings. These audio recordings may or may not be processed with machine learning or other tooling. This pronunciation database may also include phonetic representations of each name, for example “SER-shuh”. An entry may have more than one phonetic representation, for example, having a human-readable phonetic representation alongside a more precise phonetic representation usable by machine learning text-to-speech models. The database of name pronunciations may have multiple distinct entries with the same name text, for example when there is more than one viable pronunciation for a name. The database of name pronunciations may have more than one entry with the same name and phonetic, for example when two entries reflect a name pronunciation from different linguistic origins. This pronunciation database may have additional information about each entry, for example potential geographical or linguistic regions where this pronunciation is common and its relative frequency in each region. This pronunciation database may or may not be related to the pronunciation database described in FIGS. 5 and 6.

Step 410 describes a sourcing task that may occur when the pronunciation database does not have entries deemed sufficient by the recommendation model for the purpose of finding relevant pronunciations for the input in step 405. Step 410 may or may not include asking human workers who are familiar with name pronunciations from the target name's origin to provide an example pronunciation of the name; for example, if the target name is determined to be in India, then voice actors from India may be asked to generate an example audio recording of how the name is pronounced.

In step 420, a name parser model may or may not process the target name input text to adjust irregularities or to convert it into a standard “base” level. This may include removing irregular punctuation marks or even non-name words that were added by the user. This may include removing diacritics or other punctuation. For example, a text input of “L'Óreal” may be converted to “loreal”.

In step 425, a name parser model may or may not process each of the text names in the pronunciation database. This may or may not be the same name parser model as step 420.

In step 440, an algorithm may identify all potential entries in the pronunciation database that “match” up with the target name. This match may be determined entirely based on the text representation of the target name and the text representations of each of the entries in the pronunciation database. This matching function may or may not be performed by comparing the “base” level version of each text name against the base level of the target name. This matching may or may not look for exact text matches. This matching may or may not use imprecise matching, for example finding names whose Levenstein distance is below a certain threshold. This algorithm may or may not remove from consideration pronunciation database entries whose matching score falls above or below a certain threshold. If the results of this process are not ideal, the matching function may trigger the initiation of the source task (step 415) to improve the pronunciation database.

In steps 430 and 435, computer server 155 may further process information about the user and supplementary information related to the user, target individual, or other aspects of the input. This data may be utilized to extract information relevant to determining the preferred pronunciation. For example, a user may have indicated that they prefer to listen to pronunciations using USA-based phonetics and accents, and so USA-based recordings may be preferred. For example, information about the target—including but not limited to their full name, phone number, address, or other demographic information—may provide information to estimate the linguistic origin of their name and therefore the preferred pronunciation if multiple viable pronunciations are available. For example, if computer server 155 determines that a name originates in an Arab country, and that person is located in Dearborn, Mich., computer server 155 may apply census data that indicates a particularly high density of people from Somalia or of Somalian descent, to determine that the name should be pronounced in a way that is consistent with a Somali pronunciation rather than another Arabic country pronunciation. Other supplementary data may include a zip code, phone area code, name data, or other information that provides a suggestion of a locality for a particular person. The origin data extracted may or may not be a single geographical or linguistic region or ethnicity or may or may not be a list of probabilities for different regions. The linguistic origin may or may not indicate influences from multiple geographic regions across time, for example the pronunciation of a third-generation immigrant Indian name in New Orleans may differ from the pronunciation of a third-generation immigrant Indian name in New York. In addition to these, the supplementary information may include identifying information about, for example, the target individual, for whom there may be prior information regarding the correct target name pronunciation, including but not limited to saved recordings of them saying their own name. The processes in steps 430 and 435 may or may not include machine learning models or statistical techniques.

In step 445, a ranking algorithm may incorporate user preference, target origin estimation, prior target pronunciation matches, and other information derived from input supplementary information in order to rank the entries from the pronunciation database. These pronunciation entries may be ranked based on which is the most likely, most relevant or best pronunciation recording, for example. This ranking may or may not use information about the origins of each entry in the pronunciation database to match against the most likely origin of the target name as determined by the target origin estimation process in step 435. This model may or may not include a machine learning model or statistical techniques. If the results of this process are not ideal, it pay trigger the initiation of the source task (step 415) to improve the pronunciation database.

In step 455, the final output of this system is a list of pronunciations, particularly their audio recordings and/or phonetic representations, ranked based on the ranking algorithm in step 445. This may or may not include additional information such as the rating assigned to each pronunciation entry or the estimated origin of each pronunciation entry. This list may or may not be pruned, for example to only provide a certain number of results per origin. This list may or may not be restricted to only contain the single top result.

In step 450, a “voting model” interprets customer preferences and behavior based on prior results in order to provide additional information to adjust the behavior of the ranking algorithm. This may include excluding certain results that customers did not prefer or downvoted. This may include increasing the ranking for certain results that were highly preferred for a given target name, or highly preferred for a given target name within e.g., a certain demographic. This model may or may not include a machine learning model or statistical technique. Using this “voting” model, the ranking algorithm may be further iteratively refined to improve e.g., the accuracy and quality of name recommendations. Prior accurate pronunciation matches may also be used to instruct machine learning processor 165 about which pronunciation recommendations it should make based on prior success. In this manner, the ranking algorithm is constantly refined to improve recommendations for pronunciation of a name.

FIG. 5 illustrates an exemplary method 500 for converting text-based name input to an audible pronunciation of a name. Method 500 may be particularly applicable when a saved recording is unavailable or not preferred. Method 500 begins at step 505 where a user device, such as user device 150 receives text-based name input of a name, such as “Sertia.” This text-based name input may be accompanied by supplementary information that may or may not help predict the most likely pronunciation of the name. For example, the text name input may part of a larger block of text generated on a user's phone which they would like to convert into audio output. Supplementary information may also include the user's list of contact names or their geographical location. Supplementary information may also the rest of the submitted text outside of the name portion. Supplementary information may also include the prior interactions the user has made with this or related name pronunciation services.

Step 510 describes a database of name pronunciations, which may include text-based representations of names and phonetic-based representations of names. For example, an entry for “Sertia” may be linked to both the text “Sertia” as well as the phonetic “SER-shuh”. An entry may have more than one phonetic representation, for example, having a human-readable phonetic representation alongside a more precise phonetic representation usable by machine learning text-to-speech models. The database of name pronunciations may have multiple entries with the same name text, for example when there is more than one pronunciation for a name. The database of name pronunciations may have more than one entry with the same name and phonetic, for example when two entries reflect a name pronunciation from different linguistic origins. This pronunciation database may or may not be related to the pronunciation database described in FIGS. 4 and 6.

At step 515, a recommendation model combines the text-based name data input and supplementary input information with the pronunciation database to identify the most likely pronunciation entry from the pronunciation database, specifically outputting the phonetic representation for that pronunciation entry. This recommendation model may or may not be related to the recommendation model referenced in FIG. 4. This phonetic representation may also be accompanied by additional information such as the potential spoken accent or linguistic or geographical origins associated with that pronunciation.

If none of the entries in the pronunciation database fulfill the criteria for a desired pronunciation, a plausible pronunciation may be artificially generated at step 515, for example by using a machine learning model trained to convert text into a phonetic representation of a name based on linguistic rules for the linguistic origin determined to be likely for the input name. Alternatively, in the case where an immediate output is not required, the input name and supplementary information may be used to generate a task to seek a desired name pronunciation, for example by requesting individuals from the target linguistic origin to provide a potential phonetic pronunciation for the name.

At step 520, the phonetic representation of a name pronunciation may or may not be additionally processed to convert it into a format that would be better utilized as input to a machine learning system. This may consist of converting the initial phonetic representation into a different phonetic representation. Alternatively, this may involve converting the phonetic representation into an abstract representation such as a list of floats that would be utilized as the inputs to a neural network. This step may be executed using a machine learning model or a different algorithm.

At step 525, a model converts the phonetic input or other form of input into an audible pronunciation of the name. This may be accomplished through use of a text-to-speech machine learning model, or through use of a portion of a text-to-speech model. If the audible name output will be part of a longer audible speech, this model may incorporate information about preceding or following speech clips to enable better output, for example consistent tonality or natural-sounding transitions between words. Alternatively, the speech output for the name may be additionally processed to incorporate into the rest of the audio output. The final output of this process is to create a spoken/audible representation of the name, e.g., “Sertia”, to be audibly heard via a speaker.

FIG. 6 illustrates an exemplary method 600 for converting audible name input data into text-based name output data. At step 605, a user device 150 may receive spoken/audible based name input data. For example, a user may speak the name of a person, such as Sertia, into user device 150. This speech-based name input may be accompanied by supplementary information that may or may not help predict the most likely spelling, diacritics, and/or punctuation of the name. For example, the audio name input may be a portion of a larger block of audio speech spoken into a user's phone or home smart device. Supplementary information may include the user's list of contact names or their geographical location. Supplementary information may also the rest of the speech outside of the name portion. Supplementary information may also include the prior interactions the user has made with this service.

At step 610, a model may convert the audio representation of a name into a phonetic representation. For example, the model may identify phonetic constituents “SER” and “Shuh”. This model may or may not be a machine learning model such as a neural network and may or may not be related to existing speech recognition model frameworks. The phonetic output may or may not be in the form of text or may or may not be in the form of a more abstract representation such as a list of float values similar to the activation levels of units in a level of a multi-level neural network.

Step 615 describes a database of name pronunciations, which may include text-based representations of names and phonetic-based representations of names. For example, an entry for “Sertia” may be linked to both the text “Sertia” as well as the phonetic “SER-shuh”. An entry may have more than one phonetic representation, for example, having a human-readable phonetic representation alongside a different form of phonetic representation usable by machine learning models, including but not limited to representations in the form of a list of float values. The database of name pronunciations may have multiple distinct entries with the same name text, for example when there is more than one pronunciation for a name. The database of name pronunciations may have more than one entry with the same name and phonetic, for example when two entries reflect a name pronunciation from different linguistic origins. This pronunciation database may or may not be related to the pronunciation databases described in FIGS. 4 and 5.

In step 620, a model identifies pronunciation entries in the pronunciation database which may be related to the phonetic representation of the spoken input name. For example, if the output of step 610 is a text-based phonetic output “SER-shuh”, then step 620 may involve searching for pronunciations in the pronunciation database which also have phonetic representations of “SER-shuh”. This model may look for exact matches in the phonetic text representations, or it may allow imprecise matches. An example of an imprecise match may include phonetic representations which match on the critical parts of a name but differ on parts of the phonetic with high inter-rater variability, for example an input name that was converted to “SER-shuh” may match with entries in the pronunciation database for “SER-sheh” or “SER-shih”.

Alternatively, the output of step 610 may be a more abstract representation of a phonetic format that is readable by a machine learning model, and the pronunciation database may similarly have abstract representations for each entry. In this case, a match may be defined by a measure of similarity between vectors, for example cosine similarity, or, conversely, similarity may be defined by a more complex model built specifically for this purpose. Entries in the pronunciation database whose similarity falls within a certain threshold could then be considered as a potential match.

The model described in step 620 may or may not be a text-match algorithm, a similarity algorithm, or a statistical or machine learning algorithm. The output of step 620 may include the matching entries in the pronunciation database and may or may not include additional information, for example, the degree of matching as determined by the model in step 620.

At step 625, a recommendation model identifies the most likely spelling of the input name through information about each pronunciation entry such as the degree of match, potentially along with supplementary information from step 605. For example, if step 620 identified three likely entries in the database with phonetic representations, accents, and matching scores of “SER-shuh” (USA; score=0.99), “SER-shuh” (France; score=0.98), and “SER-shay” (USA; score=0.78), and the supplementary information suggested that the name target likely originates from a USA linguistic tradition, then the recommendation model may choose “SER-shuh” (USA; score=0.99) as the best-ranked option along with its corresponding spelling “Sertia”. This recommendation model may or may not be related to the recommendation model referenced in FIGS. 4 and 5. The output of this recommendation model may or may not be a single entry from the pronunciation or a ranked list of entries and their associated scores. This output may also be accompanied by additional information such as the potential spoken accent or linguistic or geographical origins associated with each potential spelling. The text representation of the name may or may not include diacritics or other punctuation such as apostrophes, dashes, or spaces. The text representation of the name may or may not include characters not found in the English alphabet.

If none of the entries in the pronunciation database fulfill the criteria for a match, a plausible spelling may be artificially generated at step 625, for example by using a machine learning model trained to convert audio into text. This may or may not be a specialized model or algorithm trained to include supplementary information such as potential origins of the name. For example, if the location of the user and the format of the name suggests that the name is likely French in origin, then the model may incorporate this information to convert the audio into a plausible spelling for French names and/or French linguistic rules. This may be accomplished for example by indicating to a neural network trained on different languages that a name is French in origin, or selectively utilizing a neural network that has been specialized to convert French audio clips into French words. Method 600 may provide an output of a text representation of the most probable name spoken in step 705 to the user by a display or by audibly spelling the letters for the user as “S-E-R-T-I-A.” Alternatively, this spelling may be utilized for other functionality, for example if the input audio was a command to a smart device to “Call Sertia”, the spelling may be used to find entries for “Sertia” within the users list of contacts in order to initiate a phone call; or if the name references a geographical or commercial location, for example “Drive to Muir Beach”, then the output spelling for “Muir” may be utilized by a navigation tool to provide directions to the desired location.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1) A system comprising:
a computer server, including a processor, which receives a request for pronunciation of a target name by a user;
a database storing one or more name pronunciations for one or more names;
wherein the computer server compares the target name received in the request for pronunciation of the target name with the one or more name pronunciations for one or more names in the database to identify a ranked list of pronunciations of the target name received in the request for pronunciation of the target name, and wherein the computer server transmits the ranked list of pronunciations of the target name received in the request for pronunciation of the target name to a user device associated with the user.

2) The system of claim 1, wherein the server receives the target name for which a request for pronunciation of the target name by the user as text from a user device.

3) The system of claim 1, wherein the server estimates a preferred pronunciation for a user.

4) The system of claim 3, wherein the estimated preferred pronunciation of the user is based on known demographic information for the target name.

5) The system of claim 4, wherein the demographic information is the full target name.

6) The system of claim 5, wherein the demographic information is one or more of a phone number of a person with the target name and an address of a person with the target name.

7) The system of claim 3, wherein the estimated preferred pronunciation of the target name is based on target name origin information.

8) The system of claim 7, wherein the target name origin information includes a language of origin for the target name.

9) The system of claim 3, wherein the estimated preferred pronunciation of the target name is based on one or more prior target pronunciation matches.

10) The system of claim 1, further comprising a user device, including a display for displaying the ranked list of pronunciations of the target name transmitted from the computer server.

11) The system of claim 1, wherein the computer server further receives positive or negative feedback from the user based on the transmitted ranked list of pronunciations of the target name.

12) A method, comprising:
receiving, by a processor, a request for pronunciation of a target name by a user;
comparing, by the processor, the target name to one or more name pronunciations for one or more names stored in a database;
identifying, by the processor, one or more name pronunciations matching the target name received in the request for pronunciation of the target name by the user;
ranking, by the processor, the identified one or more pronunciations for the target name received in the request for pronunciation of the target name by the user in a ranked list of most recommended to least recommended name pronunciations of the target name; and
transmitting the ranked list of pronunciations of the target name received in the request for pronunciation of the target name to a user device associated with the user.

13) The method of claim 12, wherein the database includes a text-based representation of the target name.

14) The method of claim 12, wherein the database includes an audio recording of the target name.

15) The method of claim 12, wherein the database includes a phonetic representation of the target name.

16) The method of claim 12, wherein comparing the target name to one or more name pronunciations for one or more names stored in the database is performed on altered text representations of the target name.

17) The method of claim 12, wherein identifying one or more name pronunciations for the target name received in the request for pronunciation of the target name by the user is based on one or more of a user preference, target name origin estimation, and prior target pronunciation matches.

18) The method of claim 12, wherein identifying one or more name pronunciations for the target name received in the request for pronunciation of the target name includes applying machine learning to identify the likelihood that one or more of the pronunciations in the ranked list of pronunciation is preferred.

19) The method of claim 12, further comprising:
receiving, by the processor, positive or negative feedback on accuracy of the ranked list of pronunciations of the target name.

20) The method of claim 12, further comprising:
displaying the ranked list of pronunciations of the target name on a screen associated with a user device.
